(19) United States
(12) Patent Application Publication
(10) Pub. No.: US 2026/0153119 A1
(43) Pub. Date: Jun. 4, 2026

(54) COMPACT COMPOSITE LET ARRAYS

(71) Applicant: BRIGHAM YOUNG UNIVERSITY, Provo, UT (US)

(72) Inventors: Larry Howell, Orem, UT (US); Luke Gardner, San Antonio, TX (US); Hunter Pruett, Provo, UT (US); Spencer Magleby, Provo, UT (US)

(73) Assignee: BRIGHAM YOUNG UNIVERSITY, Provo, UT (US)

(21) Appl. No.: 19/402,743

(22) Filed: Nov. 26, 2025

Related U.S. Application Data
(60) Provisional application No. 63/725,317, filed on Nov. 26, 2024.

(51) Int. Cl. F16C 11/12

(52) U.S. Cl. CPC F16C 11/12

(57) ABSTRACT

Disclosed herein is a Lamina Emergent Tortional device that includes a flange and a first and second slat. The first slat is bonded to the flange, and the second slat is bonded to an end of the first slat. The first slat has a width that is greater than its height. Also, disclosed is a system that implements two Lamina Emergent Tortional devices.

### PRIORITY CLAIM

This application claims the priority and benefit of U.S. Provisional Ser. No. 63/725,317 filed on Nov. 26, 2024, which is incorporated by reference in its entirety.

### BACKGROUND

Origami, the ancient art of transforming flat sheets into three-dimensional structures through folding, has long demonstrated how planar materials can be reshaped into functional forms without the use of discrete hinges or mechanical fasteners. Traditionally practiced for artistic and cultural purposes, origami principles have increasingly influenced modern engineering fields seeking to achieve complex motion and deployable structures using minimal parts. Over the past several decades, researchers have recognized that many origami folds embody relationships that can be exploited to create mechanical systems with precise, predictable motion using only a single sheet of material.

As engineering disciplines advanced, these folding principles were integrated into the field of compliant mechanisms, which produce motion through elastic deformation rather than through traditional pin joints, bearings, or sliding interfaces. Compliant mechanisms gained prominence for their ability to reduce part count, eliminate friction and wear surfaces, increase reliability, and enable scalability. Their use expanded into aerospace systems, biomedical devices, consumer products, and micro-electromechanical systems (“MEMS”). Despite these advantages, compliant mechanisms derived from origami patterns often suffer from limitations in strength, fatigue life, and motion control when implemented using rigid engineering materials.

To address these constraints, researchers developed Lamina Emergent Mechanisms (LEMs) are devices that emerge from a planar material and transform into three-dimensional functional mechanisms through strategically designed cut patterns and flexural regions. Among these, the Lamina Emergent Torsional (“LET”) joint became a foundational building block for enabling torsional rotation from a flat sheet. A LET joint generally consists of a series of geometric cutouts and thin flexure beams that create controlled torsional deformation when loaded. LET joints allow planar materials such as metals, polymers, or composites to behave like torsional hinges without the need for assembly or discrete components.

As applications expanded, multiple LET joints were often arranged together to form LET arrays, enabling distributed torsional compliance, increased rotational range, and coordinated motion across a larger structure. LET arrays made it possible to achieve more complex movements, load distribution, and multi-axis behavior using monolithic sheet-based architectures. These arrays have been integrated into deployable structures, robotic components, morphing surfaces, and other systems requiring compactness, manufacturability, and compliant torsional motion.

However, despite their advantages, LET arrays exhibit several shortcomings. Their performance is highly sensitive to kerf variations from cutting processes, leading to inconsistency in rotational stiffness and fatigue behavior. LET arrays also tend to experience parasitic out-of-plane deformations due to geometric asymmetry or unequal load distribution across individual LET joints. Additionally, the interconnected nature of arrayed LET structures can result in stress concentration, reduced durability, and limited scalability when fabricated from thin laminas. Furthermore, achieving precise torsional behavior often requires large planar footprints, which restricts integration into compact mechanisms. These limitations highlight the need for improved LET structures and methods that provide more predictable torsional performance, enhanced strength, reduced parasitic motion, and greater spatial efficiency.

### SUMMARY OF THE DISCLOSURE

Disclosed herein is a Lamina Emergent Tortional (“CLET”) system and device.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. The advantages of the disclosure will become better understood with regard to the following description and accompanying drawings where:

FIG. 1 illustrates a top view of an extended Compact Lamina Emergent Tortional device.

FIG. 2A illustrates a perspective view of a deployed Compact Lamina Emergent Tortional device.

FIG. 2B illustrates a perspective view of a stowed Compact Lamina Emergent Tortional device.

FIG. 3 illustrates a method of producing a Compact Lamina Emergent Tortional device.

FIG. 4 illustrates a perspective view of a Compact Lamina Emergent Tortional system using multiple Compact Lamina Emergent devices.

FIG. 5 illustrates a perspective view of a stowed Compact Lamina Emergent Tortional device that is part of a system.

FIG. 6 illustrates a perspective view of a deployed Compact Lamina Emergent Tortional device that is part of a system.

### DETAILED DESCRIPTION

In the following description of the disclosure, reference is made to the accompanying drawings, which form a part hereof, and in which are shown by way of illustration specific implementations in which the disclosure may be practiced. It is understood that other implementations may be utilized, and structural changes may be made without departing from the scope of the disclosure.

In the following description, for purposes of explanation and not limitation, specific techniques and embodiments are set forth, such as particular techniques and configurations, to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure may be alternatively included in another embodiment or figure, regardless of whether or not those elements are shown or described in another embodiment or figure. In other words, elements in the figures may be interchangeable between various embodiments disclosed herein, whether shown or not.

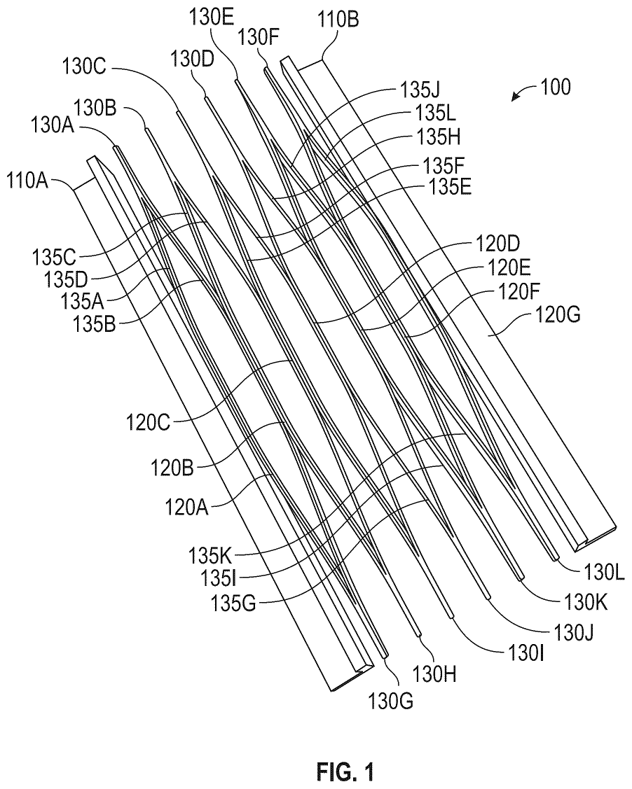

FIG. 1 illustrates the top expanded view of Compact Lamina Emergent Tortional device (“CLET”) 100. CLET 100 may be comprised of bonded segments and unbonded segments. Both bonded and unbonded portions are important to the function of CLET 100. The unbonded segments are also called the torsional segments. Since there are unbonded segments between bonded segments, unbonded segments may be determined by the number of bonding segments that a slat has. For example, slat 135B has one middle bonding segment and two end bonding segments. Accordingly, there are two unbonded segments positioned on both sides of the middle bonding segments. Alternatively, if slat 135B had two middle bonding segments in addition to the two end bonding segments there would be three unbonded segments.

Another important factor in CLET 100 is the number of slats 135A-L. A LET joint may be defined by the number of slats(s) and the number of unbonded or torsional segments (p). For example, CLET 100 would be a 12s2p joint, and this also helps define its function. The slats 135A-L of CLET 100 are shaped differently from other common LET joints, at least partly based on their manufacturing process and intended functionality. Slats may have a greater width than height and may be sized substantially similar in size. Substantially similar in this context means plus or minus 5%. The width may allow better bonding, and being thin may lessen the displacement when in a deployed position. Because the torsion segments are thin, they have very little torsional stiffness and bending stiffness in the y-direction. This results in relatively low-stiffness rotation about the x-axis (out-of-plane bending, or folding), rotation about the z-axis (in-plane bending), and deflection in the y-direction (out-of-plane shear) and rotation about the y-axis (out-of-plane twisting). Finally, most LET joints exhibit high stiffness for translation in the x-direction (in-plane or axial shear) due to the boundary conditions.

CLET 100 may be comprised of a plurality of flanges 110A or 110B using one or more of slats 135A-L. Slats 135A-L may be attached to the slat or to flange 110A or 110B. The attachment to the flange. For example, slat 135A may have a middle bonding segment 120A with a middle portion of flange 120A and end bonding segments 130A at a first end and 130G at a second end with the corresponding ends of slat 135B. Slat 135B may include a middle bonding segment 120 B with a middle portion of 135C. Slat 135C may have an end bonding segment 130B at a first end and an end bonding segment 130H at a second end, with the corresponding ends of slat 135D.

Continuing the pattern, slat 135D may include middle bonding segment 120C with a middle portion of slat 135E. Slat 135E may include end bonding segment 130C at a first end and end bonding segment 130I at a second end with the corresponding ends of slat 135F. Slat 135F may include middle bonding segment 120D with a middle portion of slat 135G. Slat 135G may include end bonding segment 130D at a first end and end bonding segment 130J at a second end, bonding with the corresponding ends of slat 135H. Slat 135H may include middle bonding site 120E with a middle portion of 135I. Slat 135I may include end bonding segment 130E at a first end and end bonding segment 130K at a second end, bonding with the corresponding ends of slat 135J. Slat 135J may include middle bonding segment 120F with a middle portion of slat 135K. Slat 135K may include end bonding segment 130F at a first end and end bonding segment 130L at a second end, bonding with the corresponding ends of slat 135L. Slat 135L may include middle boding site 120G with a middle portion of flange 110B. Flange 120A or 120B may be used to attach to an apparatus that would benefit from the aid of CLET 100. Depending on the type of CLET being produced middle bonding segment 120A-G need not necessarily be in line with one another. For example, middle bonding segment 120F may be offset to the right of center, while middle bonding segment 120G may be offset to the left of center.

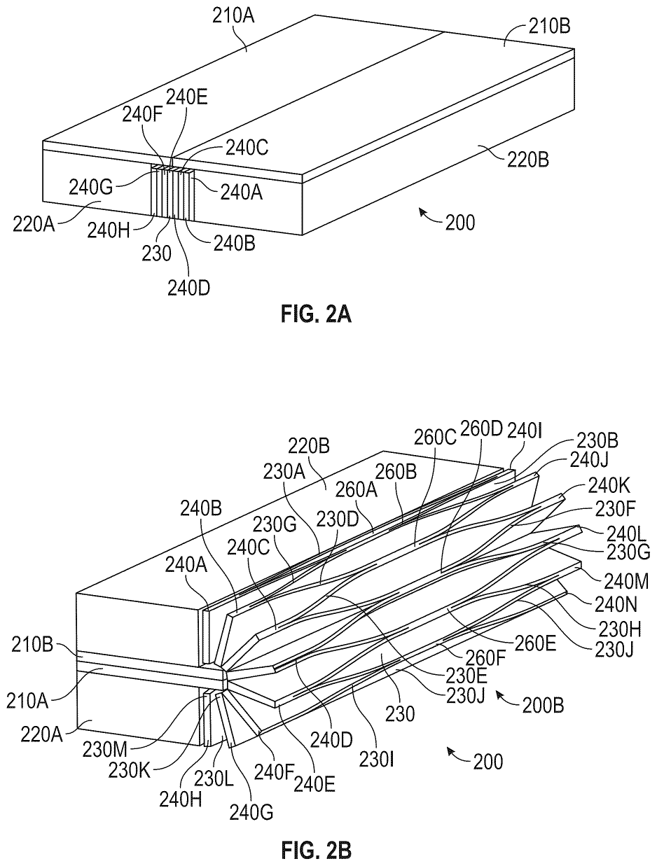

FIG. 2A illustrates a deployed perspective view of CLET 200. A deployed state of CLET may indicate the state of no deflection. CLET 200 may include flanges 220A and 220B. Flanges 220A and 220B may attach to one of slats 230, respectively. Slat 230 A-L are depicted in FIG. 2B. Due to perspective, only the end bonding segments 240A-H can be seen. The end bonding segments are the combined ends of two bonded slats 230. Because slats are in a non-deflective state, they are pulled together such that even the non-bonded sites may be touching. Flanges 220A and 220B may also attach to couplers 210A and 210B, respectively. These couplers may include magnets and or an aperture that will aid in attaching to a select apparatus.

FIG. 2B illustrates a perspective view of stowed CLET 200. CLET 200 may be comprised of bonded segments and unbonded segments. Both bonded and unbonded portions are important to the function of CLET 200. The unbonded segments are also called the torsional segments. Since there are unbonded segments between bonded segments, unbonded segments may be determined by the number of middle bonding segments a slat has. For example, slat 240B has one middle bonding segment and two end bonding segments. Accordingly, there are two unbonded segments positioned on both sides of the middle bonding segments. Alternatively, if slat 240B had two middle bonding segments in addition to the two end bonding segments there would be three unbonded segments.

Another important factor in CLET 100 is the number of slats 230A-M. A LET joint may be defined by the number of slats(s) and the number of unbonded or torsional segments (p). For example, CLET 200 would be 23s2p joint, and this also helps define its function. The slats 230A-M of CLET 200 are shaped differently from other LET joints partly at least based on their manufacturing process and intended functionality. Slats may have a greater width than height and may be sized substantially similar in size. Substantially similar in this context means plus or minus 5%. The width may allow better bonding, and being thin may lessen the displacement when in a deployed position. Because the torsion segments are thin, they have very little torsional stiffness and bending stiffness in the y-direction. This results in relatively low-stiffness rotation about the x-axis (out-of-plane bending, or folding), rotation about the z-axis (in-plane bending), and deflection in the y-direction (out-of-plane shear) as well as rotation about the y-axis (out-of-plane twisting). Finally, most LET joints exhibit high stiffness for translation in the x-direction (in-plane or axial shear) due to the boundary conditions.

A stowed state of CLET 200 may indicate the state of torsion (as depicted) and extension. In this position, couplers 210A and 210B are in contact with one another. In this position, a magnet may be positioned to secure the apparatus in a stowed position. CLET 200 may also include slats 230A-M. Slat 230A may include a middle bonding segment 260A where slat 230A attaches to the middle portion of flange 210 B. Slat 230A may also include end bonding segment 240A at a first end and end bonding segment 240I at a second end, bonding to the corresponding ends of slat 230B. Slat 230B may include a middle bonding segment 260B with a middle portion of 230C. Slat 230C may include end bonding segment 240B at a first end and end bonding segment 240J at a second end, bonding to the corresponding ends of slat 230D. Slat 230D may include middle bonding segment 260C with the middle portion of Slat 230E. Slat 230E may include end bonding segment 240C at a first end and end bonding segment 240K at a second end, bonding to the corresponding ends of slat 230F. Slat 230F may include middle bonding segment 260D with a middle portion of slat 230G. Slat 230G may include end bonding segment 240D at a first end and end bonding segment 240L at a second end, bonding to the corresponding ends of slat 230H. Slat 230H may include middle bonding segment 260E bonding with the middle portion of slat 230H. Slat 230H may include end bonding segment 240E at a first end and end bonding segment 240M at a second end, bonding with the corresponding ends of slat 230I. Slat 230I may include middle bonding segment 260F bonding to a middle portion of slat 230J. Slat 230J may include end bonding segment 240F at a first end and end bonding segment 240N at a second end, bonding with the corresponding portion of slat 230K. Slat 230K may include middle bonding segment 260G (not seen due to perspective), bonding to a middle portion of slat 230L. Slat 230L may include end bonding segment 240 G at a first end and end bonding segment 240O (not seen due to perspective) at a second end, bonding with the corresponding portion of slat 230M. Slat 230M may include middle bonding segment 260H (not seen due to perspective), bonding with a middle segment flange 220A. Depending on the type of CLET being produced middle bonding segment 260A-H need not necessarily be in line with one another. For example, middle bonding segment 240F may be offset to the right of center, while middle bonding segment 260G may be offset to the left of center. Further, there may be a plurality of middle bonding segments. For example, slat 240N may have a middle bond with slat 230M to the right of center and a middle bonding segment to the left of center with slat 230M.

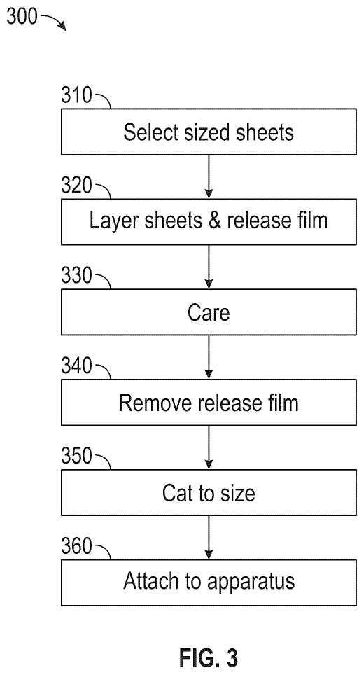

FIG. 3 illustrates a method of producing a CLET 200. The first step 310 is to select a sized sheet. Selecting the sized sheet in the first step includes selecting the appropriate type of material, such as a sheet of carbon fiber-reinforced polymer. Furthermore, these sheets may be pre-impregnated with b-staged resin. These sheets should be similar in size.

The second step 320 is to layer the sheet and release film. Release film is often used to keep the pre-impregnated sheet from bonding. This release film, appropriately placed, can dictate the target bonding portion. After the release film is placed on top of the pre-impregnated carbon fiber-reinforced polymer. Another sheet of pre-impregnated carbon fiber-reinforced polymer is placed on top, and the film is again placed to allow the target locations to bond. The second step 320 may be repeated until the CLET 200 reaches its appropriate size.

The third step 330, is curing. The curing process allows the sheet to bond together at the target locations where the release film is absent. Curing may be accomplished by removing the trapped air and then heating the stacked sheets. Curing can be done in multiple ways. For example, the air can be removed by a one-sided mold using a vacuum back and autoclave, or by squeezing the stacked sheets in a two-sided mold in a heated press.

On the fourth step 340, the release film may be removed now that the bonding portions are set after the curing is complete in the third step 330. The fifth step 330 may include cutting the sheet to the applicably sized CLET 200.

On the sixth step 360, the now cut CLET 200 is attached to the apparatus. This attachment may include attaching the CLET 200 to a flange or other connecting device to more easily attach to the apparatus. Also, the CLET 200 is positioned in the most appropriate position to allow the desired movement of the apparatus.

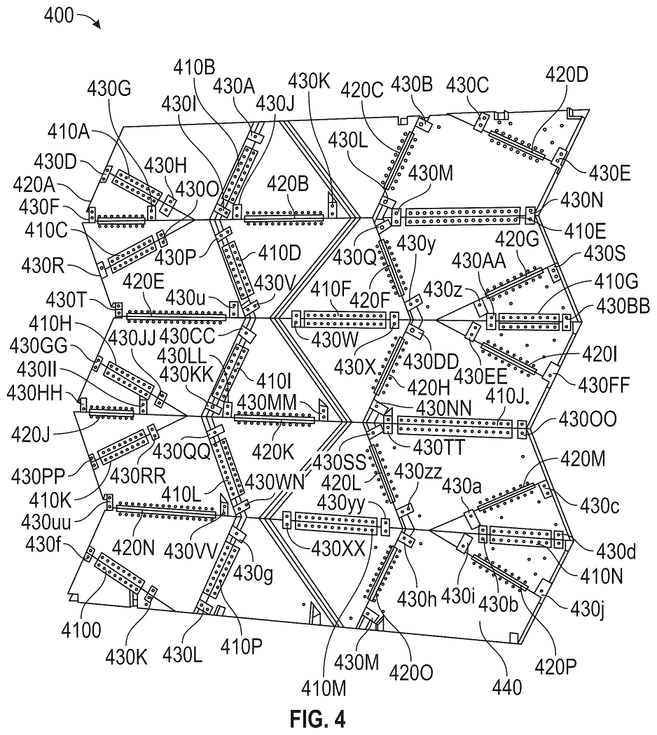

FIG. 4 illustrates the back side of system 400 using CLETs 410A-P and 420A-P in various configurations. CLETs 410A-P and 420A-P may be comprised of bonded segments and unbonded segments. These, along with their respective orientation, are important to their function. The unbonded segments are also called the torsional segments. Since there are unbonded segments between bonded segments, unbonded segments may be determined by the number of middle bonding segments a slat has.

Another important factor in CLETs 410A-P and 420A-P is the number of slats. A LET joint may be defined by the number of slats(s) and the number of unbonded or torsional segments (p). The slats of CLETs 410A-P and 420A-P may be shaped differently from other LET joints, at least partly based on their manufacturing process and intended functionality. Slats may have a greater width than height and may be substantially similar in size. Substantially similar in this context means plus or minus 5%. The width may allow better bonding, and being thin may lessen the displacement when in a deployed position. Because the torsion segments are thin, they have very little torsional stiffness and bending stiffness in the y-direction. This results in relatively low-stiffness rotation about the x-axis (out-of-plane bending, or folding), rotation about the z-axis (in-plane bending), and deflection in the y-direction (out-of-plane shear) and rotation about the y-axis (out-of-plane twisting). Finally, most LET joints exhibit high stiffness for translation in the x-direction (in-plane or axial shear) due to the boundary conditions.

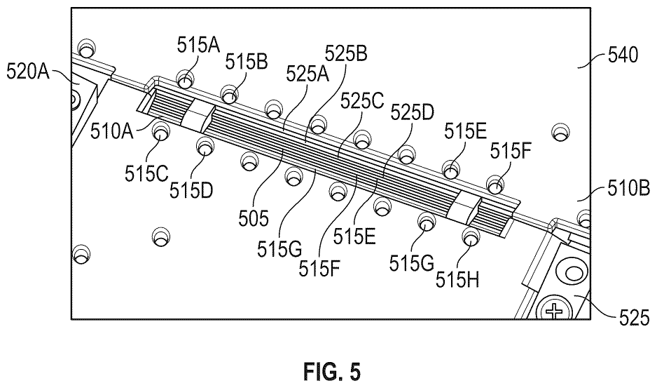

This exemplary system 400 is implemented in a Volume-Efficient Miura-Ori (“VEMO”) deployable antenna 440. Antenna 440 was intended as a reflectarray while being self-deploying, self-stabilizing, and flat. CLET system 400 includes valley fold CLETs 410A-P. Valley fold CLETs 410A-P that fold towards the front of CLET system 400. CLET system 400 also includes mountain fold CLETs 420A-P that fold towards the back of CLET system 400. Also, included in system 400 are magnets 430A-m. With valley fold CLETs 410A-P, mountain fold CLETs 420A-P, and magnets 430A-m, antenna 440 may collapse to a stowed position as illustrated in FIG. 5A. Also, with valley fold CLETs 410A-P, mountain fold CLETs 420A-P, and magnets 430A-m, antenna 440 may deploy relying on the potential energy stored by the valley fold CLETs 410A-P and mountain fold CLETs 420A-P. Magnets also aid the deployment process.

FIG. 5 illustrates a stowed antenna 540 as part of system 500. CLET 505 may be comprised of bonded segments and unbonded segments. Both bonded and unbonded portions are important to the function of CLET 505. The unbonded segments are also called the torsional segments. Since there are unbonded segments between bonded segments, unbonded segments may be determined by the number of middle bonding segments a slat has.

Another important factor in CLET 505 is the number of slats 525A-G. A LET joint may be defined by the number of slats(s) and the number of unbonded or torsional segments (p). The slats 525A-G of CLET 505 are shaped differently from other LET joints, at least partly based on their manufacturing process and intended functionality. Slats may have a greater width than height and may be substantially similar in size. Substantially similar in this context means plus or minus 5%. The width may allow better bonding, and being thin may lessen the displacement when in a deployed position. Because the torsion segments are thin, they have very little torsional stiffness and bending stiffness in the y-direction. This results in relatively low-stiffness rotation about the x-axis (out-of-plane bending, or folding), rotation about the z-axis (in-plane bending), and deflection in the y-direction (out-of-plane shear) and rotation about the y-axis (out-of-plane twisting). Finally, most LET joints exhibit high stiffness for translation in the x-direction (in-plane or axial shear) due to the boundary conditions.

System 500 may include CLET 505 in a deployed position. CLET 505 includes slats 525A-G that may bond to one another, but this is unseen due to perspective. System 500 also includes magnets 520A and 520B. System 500 also includes retainers 510A-B. Retainers may be used to help prevent overextending CLET 505 during deployment. CLET 505 may attach to antenna 550 using couplers 515A-H.

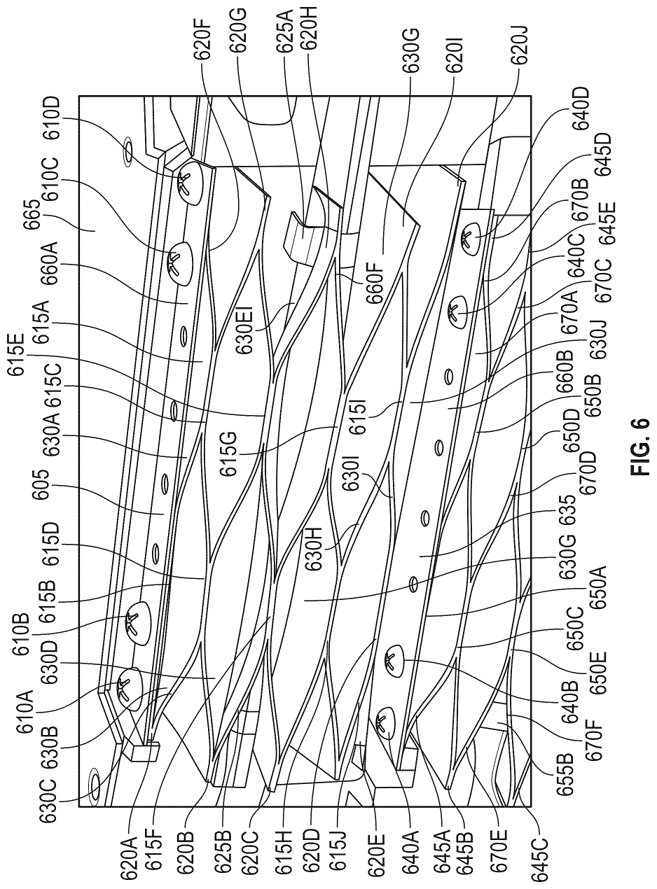

FIG. 6 illustrates a deployed antenna 640 as part of system 600. System 600 included CLET 660A and CLET 660B. CLET 660A and CLET 660B may be comprised of bonded segments and unbonded segments. Both bonded and unbonded portions are important to the function of CLET 660A and CLET 660B. The unbonded segments are also called the torsional segments. Since there are unbonded segments between bonded segments, unbonded segments may be determined by the number of middle segments that bond a slat has. For example, since 630B has two middle bonding segments in addition to the two end bonding segments are three unbonded segments.

Another important factor in CLET 660A and 660B is the number of slats. A CLET joint may be defined by the number of slats(s) and the number of unbonded or torsional segments (p). For example, CLET 660A would be a 10s3pjoint, and this also helps define its function. The slats of CLET 660A and 660B are shaped differently from other LET joints, at least partly based on their manufacturing process and intended functionality. Slats may have a greater width than height and may be substantially similar in size. Substantially similar in this context means plus or minus 5%. The width may allow better bonding, and being thin may lessen the displacement when in a deployed position. Because the torsion segments are thin, they have very little torsional stiffness and bending stiffness in the y-direction. This results in relatively low-stiffness rotation about the x-axis (out-of-plane bending, or folding), rotation about the z-axis (in-plane bending), and deflection in the y-direction (out-of-plane shear) and rotation about the y-axis (out-of-plane twisting). Finally, most LET joints exhibit high stiffness for translation in the x-direction (in-plane or axial shear) due to the boundary conditions.

CLET 660A may include slats 630A-630J. CLET 660A may include a flange 605. Flanges 605 may attach to antenna 665 using couplers 610A-610D. Flange 605 may include a middle bonding segment 615A bonded to slat 630A. 630A may include a second middle bonding segment 615B bonding to a middle portion of slat 630B. At a separate middle portion, slat 630B may include a second bonding middle segment 615C, bonding to a middle portion of slat 630C. At a separate middle portion 630C may include a second bonding middle bonding segment 615D bonding to a middle portion of slat 630D. At a separate middle portion, slat 630D may include a second bonding, middle bonding 615E bonding to the middle portion of slat 630E. At a separate middle portion, slat 630E may include a second bonding, middle bonding 615F bonding to a middle portion of slat 630F. At a separate middle portion, slat 630F may include second bonding, middle bonding 615G bonding to a middle portion of slat 630G. At a separate middle portion, slat 630G may include a second bonding, middle bonding 615H to a middle portion of slat 630H. At a separate middle portion, slat 630H may include a second bonding, middle bonding 615I bonding to a middle portion of slat 630I. At a separate middle portion, slat 630I may include a second bonding, middle bonding 615J bonding to a middle portion of 630J. At a separate middle portion, slat 630J may include a second bonding to a flange not seen due to perspective.

Slat 630A-J also includes end bonds. For example, slat 630A, a first end may be bonded to flange 605, and a second end may include end bonding segment 630F, which bonds to slat 630B. At a second end, slat 630B may include bonding segment 620A, which bonds to slat 630C. At a second end, slat 630C may include bonding segment 620G, which bonds to slat 630D. At a second end, slat 630D may include bonding segment 620B, which bonds to slat 630E. At a second end, slat 630E may include bonding segment 620H, which bonds to slat 630F. At a second end, slat 630F may include bonding segment 630C, which bonds to slat 630G. At a second end, slat 630H may include bonding segment 620I, which bonds to slat 630I. At a second end, slat 630I may include bonding segment 620 E, which bonds to slat 630J. At a second end, slat 630J may include a bonding segment to a flange not seen due to perspective. CLET 660A may include retainers 625A at one end and 625B on a second end.

CLET 660B may include flange 635 may attach to antenna 665 using one or more of couplers 640A-D. Flange 635 may include middle bonding segment 650A bonded to slat 670A. 670A may include a second middle bonding segment 650B bonding to a middle portion of slat 670B. At a separate middle portion, slat 670B may include a second bonding middle segment 650C, which bonds to a middle portion of slat 670C. At a separate middle portion 670C may include a second middle bonding segment 650D bonding to a middle portion of slat 670D. At a separate middle portion, slat 670D may include a second middle bonding segment 650E, which bonds to the middle portion of slat 670E, and so on until a slat attaches to a flange not seen due to perspective.

Slat 670A-F also includes end bonds. For example, slat 670A, a first end may be bonded to flange 660, and a second end may include end bonding segment 645D, which bonds to slat 630B. At a second end, slat 670B may include bonding segment 645A, which bonds to slat 670C. At a second end, slat 670C may include bonding segment 645E, which bonds to slat 670D. At a second end, slat 670D may include bonding segment 645B, which bonds to slat 670E. At a second end, slat 670E may include bonding a segment which bonds to slat 670F, and so on, until a slat attaches to a flange not seen due to perspective.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered as exemplary only, with a true scope and spirit of the invention being indicated by the following claims.

What is claimed is:

1. A Lamina Emergent Tortional device comprising:
a flange;
a first slat bonded to the flange comprising:
a width greater than its height, a second slat comprising:
an end bonding segment bonding a first end of the second slat to a first end of the first slat.

2. The Lamina Emergent Tortional device of claim 1, wherein the device further comprises:
a third slat.

3. The Lamina Emergent Tortional device of claim 2, wherein the third slat includes a middle bonding segment bonding together the second slat and the third slat.

4. The Lamina Emergent Tortional device of claim 3 wherein the third slat further comprises:
an end bonding segment bonding a first end of the third slat to a second end of the second slat.

5. The Lamina Emergent Tortional device of claim 3, wherein the second slat further comprises:
a second middle bonding segment bonding together the first and second slat.

6. The Lamina Emergent Tortional device of claim 5, wherein the second slat further comprises:
an unbonded segment in between the middle bonding segment and the second middle bonding segment.

7. The Lamina Emergent Tortional device of claim 2, wherein the second slat comprises:
an unbonded portion between the middle bonding segment and the end bonding segment.

8. The Lamina Emergent Tortional device of claim 1, wherein the first slat includes a second end bonding segment bonding a second of the first slat to a second end of the second slat.

9. A Lamina Emergent Tortional system comprising:
a first Lamina Emergent Tortional device comprising:
a flange;
a first slat bonded to the flange comprising:
a width greater than its height,
a second slat bonded to an end of the first slat;
a second Lamina Emergent Tortional device comprising:
a flange;
a first slat bonded to the flange comprising:
a width greater than its height, and
a second slat bonded to an end of the first slat.

10. The Lamina Emergent Tortional system of claim 9 where in the flange of the first Lamina Emergent Tortional device and the second Lamina Emergent Tortional device attach to an apparatus at different locations via couplers.

11. The Lamina Emergent Tortional system of claim 10 further comprising:
a magnet attached to the apparatus near the first Lamina Emergent Tortional device.

12. The Lamina Emergent Tortional system of claim 1 wherein the first Lamina Emergent Tortional device comprises:
a retainer.

13. The Lamina Emergent Tortional system of claim 9, wherein the first Lamina Emergent Tortional device is positioned on the apparatus as a valley fold and the second Lamina Emergent Tortional device is positioned on the apparatus as a mountain fold.

14. The Lamina Emergent Tortional system of claim 9, wherein the first Lamina Emergent device further comprises:
a third slat.

15. The Lamina Emergent Tortional system of claim 14, wherein the third slat of the first Lamina Emergent device includes a middle bonding segment bonding together the second slat and the third slat.

16. The Lamina Emergent Tortional system of claim 15 wherein the third slat of the first Lamina Emergent device further comprises:
an end bonding segment bonding a first end of the third slat to a second end of the second slat.

17. The Lamina Emergent Tortional system of claim 15, wherein the second slat of the first Lamina Emergent device further comprises:
a second middle bonding segment bonding together the first and second slat.

18. The Lamina Emergent Tortional system of claim 17, wherein the second slat of the first Lamina Emergent device further comprises:
an unbonded segment in between the middle bonding segment and the second middle
bonding segment.

19. The Lamina Emergent Tortional system of claim 15, wherein the second slat of the first Lamina Emergent device comprises:
an unbonded portion between the middle bonding segment and the end bonding segment.

20. The Lamina Emergent Tortional system of claim 9, wherein the first slat of the first Lamina Emergent device includes a second end bonding segment bonding to a second end of the first slat and to a second end of the second slat.
